(19) United States
(12) Patent Application Publication
(10) Pub. No.: US 2015/0142732 A1
(43) Pub. Date: May 21, 2015

(54) CONTINUOUS IMAGE ANALYTICS

(71) Applicant: CORISTA LLC, Concord, MA (US)

(72) Inventors: Charles P. Pace, Manchester Center, VT (US); Eric Wirch, Concord, MA (US)

(21) Appl. No.: 14/543,875

(22) Filed: Nov. 17, 2014

Related U.S. Application Data
(63) Continuation of application No. PCT/US14/65850, filed on Nov. 15, 2014.
(60) Provisional application No. 61/905,027, filed on Nov. 15, 2013.
(60) Provisional application No. 61/905,027, filed on Nov. 15, 2013.

(51) Int. Cl. G06F 17/30

(52) U.S. Cl. CPC G06F 17/30247
USPC 707/609; 707/722

(57) ABSTRACT

A method, system, and computer-readable set of instructions on a storage medium are provided for querying, analyzing, and processing image data and data/metadata associated with the image data. For example, a tissue sample is made into a slide. A digital or electronic image is made of the slide. That electronic image is then parsed with respect to color, brightness, magnification, intensity, and other available image parameters. The parsed information is then used in searching and reiteratively searching a database of images from one or more sources. If different magnification levels are observed, the images are normalized and/or color corrected. If different types or levels of results are desired, a difference magnification version of the image can be used, searched, and reiteratively searched for in a database of images from one or more sources. The database can be a dynamic database which is continuously being updated, enlarged, and/or reduced.

### CROSS-REFERENCE TO RELATED APPLICATIONS

This application claims priority to U.S. Provisional Patent Application Ser. No. 61/905,027, filed on Nov. 15, 2013, entitled “Continuous Image Analytics,” and PCT International Patent Application Serial No. PCT/US14/65850, filed on Nov. 15, 2014, entitled “Continuous Image Analytics,” each of which is herein incorporated by reference in its entirety.

### COPYRIGHTS

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### FIELD OF INVENTION

A method, system, computer-readable set of instructions on a storage medium (e.g., non-transitory storage medium) is provided for querying, analyzing, and processing data; and, in particular, for processing samples for use in a digital system, querying an image database, iteratively processing the image data, and producing image data results.

### BACKGROUND

When prompted by a query, relevant data may be retrieved from data repositories. However, in existing database-query systems, a semantic gap exists between the user's conceptual expectations (for example, as conveyed through the query) and the data's low-level representation of the data. More specifically, in the context of tissue imaging, there also exists a semantic gap in attribution of meaning that exists between the low level representation of microscopy tissue digital images and a user's intentions or the intentions conveyed by a query. The magnitude of the semantic gap precludes the general application of content-based image retrieval techniques, where irrelevant results may be returned when the query is too general, and relevant results may be excluded when the query is too specific.

A challenge of the semantic gap may be attributed to the complexity, variability, and magnitude of the data. These factors complicate, e.g., act counter, to the discriminatory elements of algorithms, sometimes ultimately manifesting as an error model dominating the pattern models of the image data when the algorithm is expanded beyond a constrained application domain. Another challenge is the practical approximation assumptions that may be made when applying algorithms to large amounts of image data. These approximations are subsets and summaries of the image data that are meant to make the algorithm computationally tractable. In the case of tissue image data, the scale of the data is a great magnitude and the discriminatory features are intricate and have distinct meaning at different scales.

### SUMMARY

The present invention provides a computer-implemented method to search a database of images based on a query, the method including: responsive to a determination that a magnification level of the query is greater than a first threshold, returning a first list of result tiles satisfying the query at the magnification level of the query; responsive to a determination that the magnification level of the query is one of below and equal to, the first threshold, retrieving tiles at a next lower magnification level and returning a second list of result tiles satisfying the query at the next lower magnification level; and processing each list of result tiles, the processing including, for each result tile: adding the result tile to a subset of result tiles; responsive to a determination that a total number of result tiles in the subset is one of: greater than and equal to, a second threshold, recursively searching the subset; saving results of each recursive search of the subset to a remaining subset; recursively searching the remaining subset; and saving results of the search of the remaining subset. In an embodiment, each level of magnification corresponds to a level of a quad tree, each level of the quad tree containing a tile representing an image result. In an embodiment, a child tile has coherence with a parent tile. In an embodiment, the parent tile is at least one of: a down-sampling and a low-pass spatial filtering, of at least one of the corresponding child tiles. In an embodiment, the retrieving of tiles at the next lower magnification level includes generating children at a next lower level of the quad-tree. In an embodiment, the query includes at least one of: a minimum threshold number of results and a maximum threshold number of results. In an embodiment, the threshold number of results is based on system resources. In an embodiment, the query includes an image and the magnification level of the query is a magnification level of the image. In an embodiment, a result tile is included in the list for returning based on at least one of: a magnification of the result tile, the query image, a file name for an index associated with the result tile, a result size, and an index type. In an embodiment, the query includes a time limit within which to perform the search. In an embodiment, the query includes a threshold level of quality. In an embodiment, the first predetermined threshold is defined such that the method terminates responsive to a determination that a number of search results are below a value. In an embodiment, the first predetermined threshold is defined to correspond to a number of levels of magnification. In an embodiment, the first predetermined threshold is defined such that depth-based search is not used. In an embodiment, a level of magnification has a higher resolution than a lower level of magnification. In an embodiment, a level of magnification has twice the resolution in each dimension than a next lower level of magnification. In an embodiment, the query is updated after returning the first list of result tiles. In an embodiment, further including removing results from at least one of: the first list of result tiles and the second list of result tiles prior to processing the respective list of result tiles. In an embodiment, the processing of each list of result tiles further includes: clearing the subset following the saving of the results of each recursive search and clearing the remaining subset following the saving of the results of the recursive search of the remaining subset. In an embodiment, the recursive search is a depth-first search. In an embodiment, the saved results are available prior to termination of the search.

In an embodiment, a method and system of performing a recursive search of a tile set based on a query tile, including: for each tile in the tile set, performing the following steps until a result set is populated: retrieving a set of tiles from the next level; adding the next level tile set to the result set; responsive to a determination that a magnification level is at a predetermined target level, evaluating a quality of matches in the result set; responsive to a determination that a magnification level is below the target level, for each tile in the result set: responsive to a determination that a number of tiles in a subset is at least one of: greater than and equal to a third threshold value, adding the tile to the subset; responsive to a determination that a number of tiles in the subset is less than the third threshold value, performing the steps of: recursively searching the subset; adding results of the recursive search to a temporary result set; and clearing the subset; recursively searching the subset; adding search results to the temporary result set; clearing the subset; and returning the temporary result set. In an embodiment, the query tile is included as a first child tile of a first tile of the tile set. In an embodiment, the evaluating of the quality of matches includes determining whether a first tile in the result set has a match value of less than a predetermined value compared with the query tile. In an embodiment, the predetermined value is 50%. In an embodiment, the quality of matches is based on a difference between vectors. In an embodiment, the difference between vectors is based on a distance between the vectors of respective tiles. In an embodiment, the difference between vectors is based on a mean squared error between the vectors of respective tiles. In an embodiment, each pixel of a tile has at least one value representing at least one of: a color and a luminance of the respective pixel and each tile includes a vector of the at least one value for all pixels of the tile. In an embodiment, the query includes the predetermined value for evaluating the quality of matches. In an embodiment, sorting the returned temporary result set based on matching to the query. In an embodiment, sorting the temporary result set based on matching to its corresponding parent tile.

In an embodiment, a computer-implemented processing execution plan, including: at least one selectable probe feature specification including at least a spatial position and an extent of an image feature; at least one target specification including a set of images, the set of images including at least one image of a microscopy slide; and a traversal plan including an order of comparison and a comparison operator to generate correlation samples between the at least one selectable probe feature and the at least one target specification, wherein the correlation samples includes a similarity method, a similarity metric, the at least one selectable probe feature specification, and the at least one target specification and the extent of the image feature. In an embodiment, the traversal plan includes: at least a method of ordering samples and applying a similarity metric to establish a correlation relationship with the at least one selectable probe feature specification; data including the correlation relationship is retained in a persistent computer memory usable by traversal plans to adapt the processing execution plan to evaluate correlations. In an embodiment, the traversal plan is based on evaluating the samples in an order, the order defined by at least one of: a statistically uniform sampling including a uniform lattice; a quadtree decomposition of the slides; an embedded zero tree of the slides; an exhaustive sampling; a sparse sampling; and a scale and proximity biased sampling. In an embodiment, a bias is adaptively applied in a transitive manner such that at least one correlation with previously correlated data are usable to predict the correlation with the respective data. In an embodiment, online machine learning is used to bias the sampling and the traversal plan. In an embodiment, in which relevance feedback from a user is used to bias the sampling as the traversal plan is executing. In an embodiment, the traversal plan defines result parameters usable to determine samples to be returned as part of a result set; the parameters include a magnification scale and a spatial extent; and the processing execution plan defines an order in which samples are evaluated, the order determining a rate at which result set samples are returned. In an embodiment, scale-based dependency trees are defined based on an isolation of a respective evaluation state; and the respective isolation of the scale-based dependency trees are distributed to discrete processing elements for parallel evaluation. In an embodiment, presenting a defined partition of data independent from other data partitions; and generating an intermediate set of data for a partial result. In an embodiment, the partitioned data and the processing specification are stored on the same storage device. In an embodiment, partitioning is based on a number of result samples returned per sample evaluation such that the partition size is at least one of: increased and reduced. In an embodiment, a transformation process applies to at least one image processing transformations to the result set; and an output of the transformation process includes a transformed sample placed in persistent storage. In an embodiment, probe samples and target samples are selected from available transformed samples and secondary samples to form a traversal plan such that upon execution of the traversal plan, resulting samples are returned as secondary result samples. In an embodiment, the secondary result set samples are used to adaptively bias a primary traversal plan; and strong correlations based on the secondary result set indicate that associated samples in the primary traversal plan are to be evaluated in a preferential manner. In an embodiment, the secondary result samples are adaptively biased by further transforming the secondary result samples to generate tertiary transformed samples; and the adaptive biasing of the secondary result set to the primary result set extends to the tertiary result sets biasing of the secondary result set. In an embodiment, the adaptive biasing of upstream and downstream plans is used in a chain. In an embodiment, a graph topology is used for the adaptive biasing.

In an embodiment, a computer-implemented method of continuously processing a repository of image data, including: receiving query specification including a request for data; receiving system specification of the computer on which the method is implemented; comparing the query specification and the system specification to determine a domain specification; initiating a query on the repository based on the domain specification; receiving results of the query including image data; rendering an interactive and iterative exploration of the result image data on a graphical user interface; receiving input of the result image data via the graphical user interface; updating the query based on the received input; rendering an updated the graphical user interface based on updated result image data. In an embodiment, the repository of image data includes digital microscopy data. In an embodiment, the repository of image data includes tissue image data of a scale such that approximations of the data at a coarse scale do not have correlations with the data at a fine scale. In an embodiment, the continuous process of the image data generates results in an incrementally such that results are available prior to full termination of the processing. In an embodiment, the query specification implicitly defines indexes and transformation of data.

In an embodiment, a computer-implemented method of transforming image data in a data repository based on a query, including: receiving a query for data in the data repository, the query including at least one probe tile and at least one group of slides from which the query will run; recursively searching through each magnification level the data repository until an overlap between the query and the probe tile is spatially relevant; refining the query based on results of the recursive search; generating a traversal plan for target slides based on the recursive search; and transforming data based on data returned by the query, wherein the transformation includes adjusting at least one of: an individual pel position and a color depth of the data. In an embodiment, an overlap is spatially relevant responsive to a determination that there is an overlap of at least 256 pixels. In an embodiment, the query includes a search predicate and a query target. In an embodiment, a probe feature specification includes the search predicate specified as a region of interest, the region of interest including a point on an image with a specified extent. In an embodiment, the probe feature specification includes at least one tile, the at least one time including a set of images that the probe feature specification will target to generate search matches. In an embodiment, a traversal plane includes an order in which targets are compared with at least one probe feature specification. In an embodiment, each of the probe feature specification and the target is at least one of: a tile, a single image, a sub-image of a microscopy slide image at a level of magnification.

### BRIEF DESCRIPTION OF THE DRAWINGS

FIG. 1 is a flowchart illustrating a method of interactive data exploration according to an example embodiment.

FIG. 2 is a flowchart illustrating an exploration lifecycle according to an example embodiment.

FIG. 3 is a block diagram of a query unit according to an example embodiment.

FIG. 4 is a block diagram of an analysis unit according to an example embodiment.

FIG. 5 shows an architecture of a query unit in an intermediate stage according to an example embodiment.

FIG. 6 is a block diagram of repository elements according to an example embodiment.

FIG. 7A shows an example embodiment.

FIG. 7B shows an example embodiment.

FIG. 8A shows an example embodiment.

FIG. 8B shows an example embodiment.

FIG. 9 shows an example slide layout according to an embodiment of the present invention.

FIG. 10 shows an example slide or tile feature comparison according to an example embodiment.

FIG. 11 shows an example tile spatial decomposition according to an example embodiment.

FIG. 12 shows an example tile scale decomposition according to an example embodiment.

### DETAILED DESCRIPTION

A method and system and computer-readable instructions (which can be stored on a storage medium) for processing data (e.g., image data) in a continuous manner is provided to addresses challenges presented by the semantic gap. In an embodiment, the method is driven by a query (which can represent a user's intentions), the system's capabilities, and the system's guiding of the user. Through at least one of querying, analysis, and processing of the data, the method can provide an interactive and iterative exploration of the data. For example, the present invention provides an exploration of image data that is targeted at unique requirements of tissue image data and other biological image data. Multiple uses for the present invention are envisioned. For example, the present invention can be used with respect to any image in any industry including photography, satellite images, et al.

In an embodiment, the exploration method and system provides the user with immediate feedback on query scope and results, which facilitates immediate refinement of the query. The method can further enable specification of analysis and processing to be performed on the image data results returned from a query.

In an embodiment, the query specification implicitly defines derived indexes and transformations of the data. In an embodiment, the definition produces results for the queries that are responsive to the results from the definition. In an embodiment, the results are pre-computed, computed on demand, and/or computed during a previous exploration. In an embodiment, the results are incrementally returned based on at least one of: user experience requirements, user query specification/refinement, and system capabilities. In an embodiment, a multitude of query, analysis, and processing steps are chained with the iterative processing of each of those steps. The combination of these steps can represent a pipeline of processing.

In an embodiment, system and method elements provide the means by which the system continuous resolves of the processing pipeline. In an embodiment, results of the processing are produced in an incremental manner, and can be provided to the user and/or later stages in the pipeline. This can be advantageous, for example, because no single pipeline step is required to completely process all of the data. For example, the results are provided as they are found by the processor(s). And, as certain results are selected as being more relevant, then the query is updated with this information and the subsequent searching and findings by the processor(s) include this updated query and the processor(s) continues its search previously begun. In an alternative embodiment, the search is begun anew as the query is changed.

In an embodiment, the system and method include and can prioritized as follows: archival, storage, transfer, and analysis. Archival can include retention and replication of the data (e.g., tissue image data), which can assure that the data can be stored long term without frequently moving the data. Performing the processing on the data while it is archived can involve moving the computational processing of the data local to the data itself rather than moving the data local to the processing. Storage can provide access to the data through providing decimated multi-scale representations. Storage can organize the data to decrease access latencies and manage the derived data storage and loading as well. Transfer can limit the requirement to transmit the data or derived data. For example, transfer can delay transfer of data to downstream processing where the derived data is smaller, and perform the analysis and transformation of the data local to the data itself, and return the result.

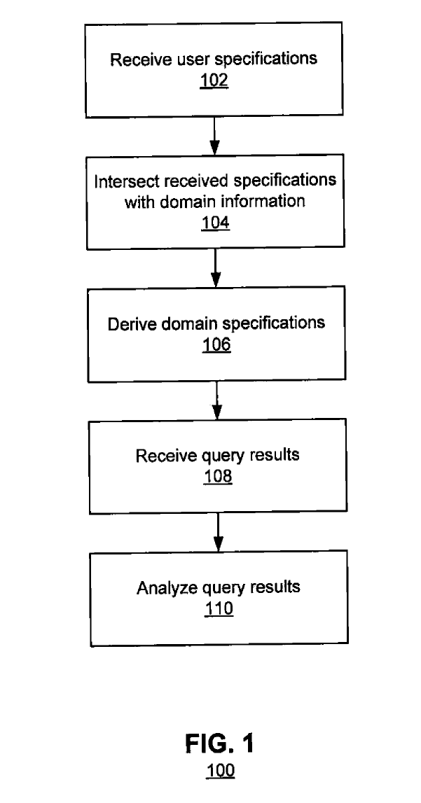

FIG. 1 is a flowchart illustrating a method and system 100 of interactive data exploration according to an example embodiment. The method and system 100 includes an order of operations for exploring repository information. In step 102, a User Specification can be defined based on the data extraction requirements of the user. In step 104, the User Specification defined in step 101 is intersected with a domain specific information in the repository, which can then, in step 106, produce the related Domain Specification. The combined User and Domain Specifications (steps 102 and 106) can be used to initiate a query on the repository that may generate Query Results in step 108. The generated results can be supplied to an analysis process that generates an analysis of the results in step 110.

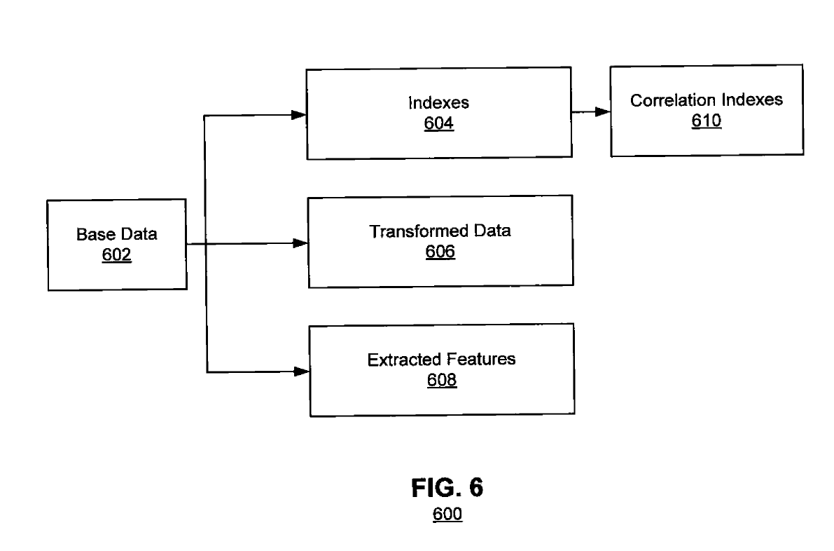

FIG. 6 is a block diagram of repository elements 600 according to an example embodiment. In this example, the repository elements include Base Data 602 of the repository, which can be a quad-tree decomposition of slide image data, each parent layer subsampled once and each layer divided (e.g., decimated) into tiles corresponding to those of the tree elements. An Indexing 604 of the tiles can be defined based on one or more feature extractions 608. The feature extraction 608 can be isolated to the state of each tile. Correlation Indexes 610 can be defined based on index similarity, indicating the correlation of two or more tiles based on one or more indices 604. The Base Data 602 can be a transformation of imported data 606.

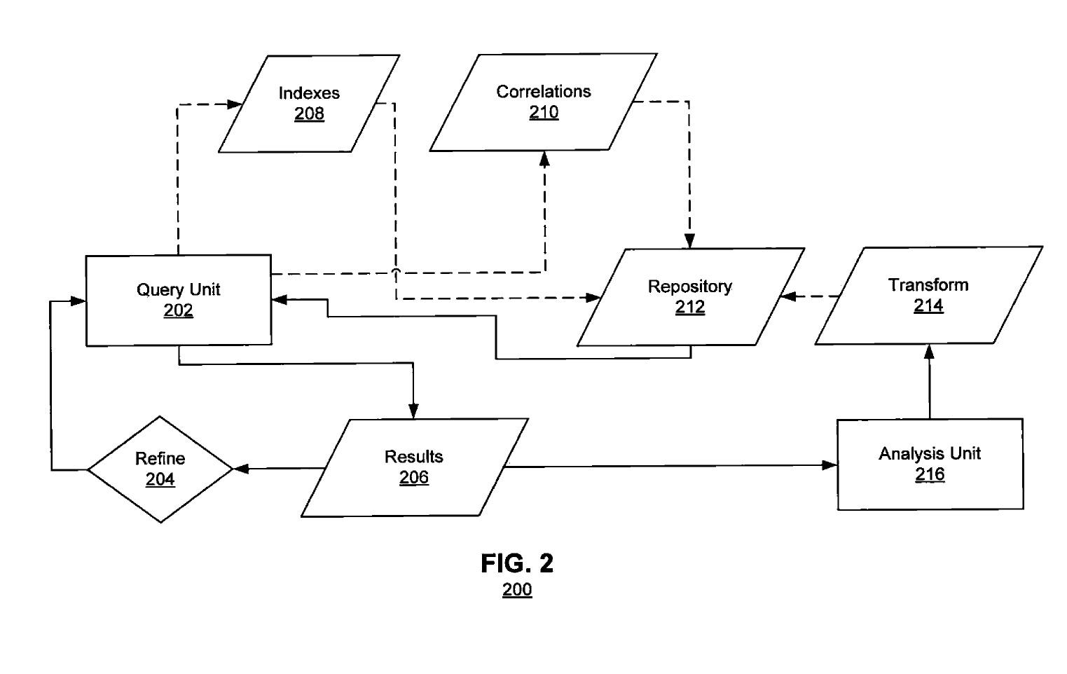

FIG. 2 is a flowchart illustrating a repository exploration lifecycle 200 according to an example embodiment. In an embodiment, the exploration is a combination of query and analysis performed in a sequence by Query Unit(s) 202 and Analysis Unit(s) 216. For example, a Query Unit(s) 202 includes a query target, for which an index 208 and/or correlation 210 is identified based on, e.g., a feature extraction. The information of the index and correlation are stored in a repository 212. The results 206 obtained through the Query Unit(s) 202 are sent to the analysis unit 216 and/or to a refine unit 204. After the analysis unit 216, the results are sent to the transform unit 214 which can then be sent to the repository 212. The various information stored in the repository 212 can be sent to the Query Unit(s) 202. The refining 204 of the results 206 can also be sent to the query unit to update the search.

In an embodiment, a Query Unit(s) 202 includes a search predicate and a query target. A probe or probe feature specification is used herein to refer to the search predicate specified as a region of interest, or, e.g., being a point on an image with a specified extent. A target specification is used herein to refer to a set of target images which the probe will target in order to generate search matches, and/or a set of images (e.g., digital images) that make up the tiles of one or more microscopy slides. In an embodiment, when an entity selects one or more of the target images or tiles, that selection becomes the probe. A traversal plan is used herein to refer to a composition of the order in which a target from the target specification is computer with one or more probes. In an embodiment, each individual comparison is between one probe and one target. In an embodiment, the comparison is between at least one probe and at least one target. In an embodiment, the probe and the target are at least one of: a tile, a single image, a sub-image of a microscopy slide image at a specific scale or magnification. In an embodiment, the traversal plan is a breadth-first traversal of a multi-scale quad-tree decomposition of the microscopy slide image. In an embodiment, the traversal plan is a depth-first traversal of a multi-scale quad-tree decomposition of the microscopy slide image. In an embodiment, the traversal plan is a depth traversal, and then a breadth traversal. In an embodiment, the traversal plan is a breadth traversal, and then a depth traversal.

In an embodiment, a user, e.g., a pathologist, administrator, or a processor, selects one or more probe tiles to be used in a query of the tissue image repository. The user also selects a group of slides on which the query will be run. Upon execution of the query, the features are extracted from the probe tile image(s) based on the query specification. For example, a color histogram feature extraction is used. In an embodiment, when a feature is extracted, it is persisted to long term storage to prevent the recalculation of the feature. The persisted collection of one or more feature vectors on disk is defined as an index. The feature vector is extracted from lower magnification scales of the slide that include the probe tile. In an embodiment, the process recurses up lower magnification levels until it reaches a level for which an overlap with the probe tile is still spatially relevant, e.g., the top level. In an embodiment, this spatial relevance is an overlap of 256 pixels. The extraction of features from the top level probe overlap tile, and the intermediate magnification level probe overlap tiles is defined as a scale probe tile set for the individual probe tile. In an embodiment, the collection of all the tile sets for all the probe tiles, collectively the total probe tile set, is utilized to generate the traversal plan for the target slides. In an embodiment, this total probe tile set elements are combined based on their magnification level. These collections of elements, e.g., the features extracted from them, are used to order sets of candidate target tile's extracted features to generate a traversal plan. In an embodiment, the features are extracted for the target tiles at the corresponding magnification level and compared with the probe set. The target candidates are then ordered base on a similarity measure of the feature vectors. In an embodiment, the comparison operator is the L2-norm of the two vectors. In an embodiment, the traversal plan is this ordered list, which is traversed in order of similarity, then the tiles on the next higher magnification are compared to the corresponding probe set tiles in the defined feature space (e.g., color histogram, in this example). The results are ordered again, and then the recursive operation continues down to stronger magnification levels. In an embodiment, the traversal plan is specified as being breadth-first or depth-first, determining whether higher magnification levels are recursed before all current magnification level evaluations are completed. For example, the depth-first has the advantage of yielding results to the user with a lower latency due to fewer evaluations being performed.

In an embodiment, the results being returned from the execution of the query using the traversal plan are displayed on the user interface. In an embodiment, at any time that the results are being displayed on the user interface, the user can choose to alter the query parameters, adding or removing probe tiles, adding or removing target slides, and providing relevance feedback for the results that are returned. In an embodiment, the addition/removal of probe tiles and slides alters the traversal plan through simple set operations applied to the existing sets of probe tile features. In an embodiment, the relevance feedback is used to change the order of the traversal and also serve as a biasing factor in the similarity criteria. The relevance feedback can be specified in the user interface as a plus or minus, corresponding to positive and negative feedback.

In an embodiment, during the execution of the query using the traversal plan, the user can specify one or more additional queries that target the results of the first query. The subsequent queries operate on the results of the previous query, searching the result set. In an embodiment, the primary query is based on the extraction of color histogram features, and the second query is a more complex feature based query, e.g., one based on the characterization of texture. In an embodiment, the second query is based on the orientation of the texture, e.g., a sparse Gabor histogram feature extraction.

In an embodiment, the user specifies an analysis transformation to be performed on the results of the query. As query results are generated, the transformation process transforms the result tile into the transformed version. In an embodiment, the transformation performs an image processing morphological operation to erode and dilate image features in the result tile for the purpose of showing spatial support. In an embodiment, the transformation processes is a deconvolution operation that separates the colors associated with a stain used in the preparation of the tissue that has been imaged. In an embodiment, tissue quantification operations are performed to identify and localize tissue, such as cell nuclei, stroma, and glands. In an embodiment, the localization and identification of these structures is then used to transform the result tiles and amplify the targeted cell structures.

In an embodiment, as the query results are incrementally generated, they are passed to a defined analysis process that generates one or more transformed results for each result returned. In an embodiment, the process retains the transformed results for processing and query operations. The retention allows these tiles to be used in any manner by which the original tiles were used. For example, one or more transformed tiles can be specified as query tiles, a query operation will be executed across the transformed results as they are generated. Those transformed results are generated from the original query operation on the original tiles. In an embodiment, any of the relevance feedback and/or addition of query tile operations can be performed while the query is executing.

In an embodiment, the combinations of queries and analysis transformations are chained together, the output of a query process becoming the input of a transformation process and then the resulting output being the input of another query process. In an embodiment, this chain of query and analysis processing does not have a practical limit. For example, in this processing chain, the process would start with the user selecting several query tiles from the base layer of images. Then, the user would select the slides on which to target the query. Then, an index would be chosen for the query, such as one based on color histogram, and the user selects run. The query then begins to generate results as it is running. The user specifies that the results should be analyzed, and that the analysis should perform a color deconvolution on the result tiles, resulting in a transformation of each of those tiles into a separate, e.g., H&E stain tile (Hematoxylin & Eosin). The transformation results are generated and presented to the user. As the query process generates more results, they are then automatically transformed and presented to the user. The user then selects one of the transformed tiles, e.g., one corresponding to the Hematoxylin stain, as a query tile. To this query, an index is chosen based on a texture feature extraction. The query is executed, and the results are determined from the transformed Hematoxylin tiles. As more results are generated at each step in this chain, the process returns more results.

In an embodiment, the process embodiments discussed here are executed when a new slide is added to the image repository. In an embodiment, the similarity metric of the end results are then thresholded, results above an alert threshold are forwarded to an alerting system. In an embodiment, the slide being added to the repository triggers the processing pipeline, and the alert notifies the user for review of the new slide and the result set tiles associated with the pipeline. This is an automated screening process for scanned slides, utilizing existing processing pipelines to automatically process slides that are added to the system and generate alerts for notification or further processing. The automated processing can be used for screening slides for a multitude of purposes, including abnormal tissue detection or quality assurance.

In an embodiment, the query tile is specified from a source slide. The scanned specimen slide is stored in an arrangement of a series of tiles at different scales. The highest scale is the original magnification at which the slide was captured. This magnification is typically 40 times optical magnification. The high scale tiles are subsampled into lower scales, each representing half of the previous scale's magnification. For example, if the highest scale is 40×, the next highest scale is 20×, then 10×, followed by 5×, 2.5×, 1.25×, 0.62×, and 0.31×. For example, at the lowest scale, the typical tissue sample occupies four to eight tiles, each being 256×256 pels. In an embodiment, a target slide is specified over which the search for matches of the query tile is performed. For example, the order in which the target tiles are compared to the query tile can occur in an exhaustive traversal of the tiles at the same magnification as the query tile using a comparator that is based on the L2 norm of the pels of the compared tiles. In an embodiment, a multi-scale search and comparison is performed utilizing one or more available scales of lower magnification to generate match hypotheses that are confirmed at ever increasing magnifications, until the target magnification is reached.

The magnifications are halved with each successive scale, halving the number of pels in each dimension, making the composite of the tiles at each scale a subsampling of the previous higher magnification scale. A tile at one scale will correspond to four tiles at the next higher magnification. This correspondence matches a quad-tree decomposition of the full scale original highest magnification slide image. The present invention traverses this quad-tree with each tile being a node in the tree and each spatial correspondence being a branch of the tree.

In an embodiment, a traversal of the quad-tree for a multi-scale search utilizes matches of spatially corresponding lower magnification tiles to infer the presence of matching candidates at higher magnifications, up to and including the query tile's magnification. In an embodiment, the base traversal compares corresponding lowest magnification tiles to the query tile in order to prioritize the subtrees for those tiles for further comparison. In an embodiment, for the lower magnification level, the tiles are ordered based on their similarity criteria. In an embodiment, one or more of the lowest similarity tiles are discarded based on their similarity being below a certain threshold. In an embodiment, the threshold is a 0.70 correlation of the feature vectors derived from the tiles. In an embodiment, the feature vector for each tile is a histogram of 32 bins based on the summation of the spectral content of each tile. For each retained tile, the four corresponding tiles at the next higher magnification are added to a new collection of tiles. The collection of tiles is evaluated based on the same process as the previous level, and this recursive process continues until the base magnification is reached. In an embodiment, the correlation threshold starts at a weaker 0.50 and is increased in increments for each magnification level, up to 0.80. This described embodiment is the breadth-first traversal of the quad-tree, comparing the corresponding lower magnification query tiles to the search corresponding search tiles on the current level before moving down to the next higher magnification. This is processing the recursion for the next level based on all the current level matches in a single batch. In an embodiment, it performs the recursion in batches that are equal partitionings of this single batch. Each of the smaller batches is likewise recursed into the higher magnification levels. In an embodiment where the batch size is a single tile on the current level, the quad-tree traversal is a depth-first traversal of the quad-tree. The per level batch size being variable between a single batch (breadth-first) to a single tile per batch (depth-first) is called an adaptive traversal.

In an embodiment, an adaptive traversal is set to breadth-first at the start of the search. As the search progresses, the computation cost is computed as the number of similarity operations performed. For the computational cost, for example, the number of search results returned per comparison determines the incremental search result latency. For example, if the number of similarity comparisons is 200, and the number of results returned, using a similarity metric of 0.90 for correlation, is 40 results, then the ratio of comparisons to results is 200 to 40, that is, a result latency of 5 correlations per result. Under such a circumstance, the breadth-first partitioning of all the current level tiles into a single batch operation is determined to be efficient. Should the result latency increase to an amount above a certain threshold, such as 50, that would signal the adaptive traversal mechanism to increase the number of batches per level to, for example, two batches. Should the result latency still be over the threshold, the number of batches would be increased to three batches per level. The thresholds can be set to whatever the administrator or system prefers or requires. In an embodiment, the adaptive mechanism trades off the per-level processing efficiency for targeting the highest similarity results before moving onto the lower similarity results, a depth-first processing. At a certain point, the number of batches would equal the number of tiles on the current level, this case would be equivalent to the strict depth-first traversal of the quad-tree.

In an embodiment, the adaptive transversal incrementally subdivides the batching operation to increase the number of batches per level with the objective to decrease the result latency. For example, if the process reaches the depth-first full partitioning of the batch and the result latency has increased, the process can decrement the number of partitions to search for a lower result latency. In an embodiment, a computational budget is specified to determine the number of subtrees that are evaluated.

In an embodiment, a sampling function for accessing data (e.g., tissue image data) is provided. The sampling function here defines the order in which the data is accessed. The function can formulate the access plan based on constraints that are predicted from the data itself and based on the user interactivity. These constraints on the sampling function can constitute the query context of the invention.

In an embodiment, sampling is constituted of an access plan based on the user specification and the system specification. The user specification can include the scope of the data to be searched along with any predicate specifications. The system specification can include the existing data and the remaining results of previous processing. The sampling function can return sets of partial results in an incremental manner. Those returned results can then be used to modify both the user specification and the system specification within the current query context. The refinement operation can interrupt the processing such that the query is guided towards more relevant result sets (e.g., samples).

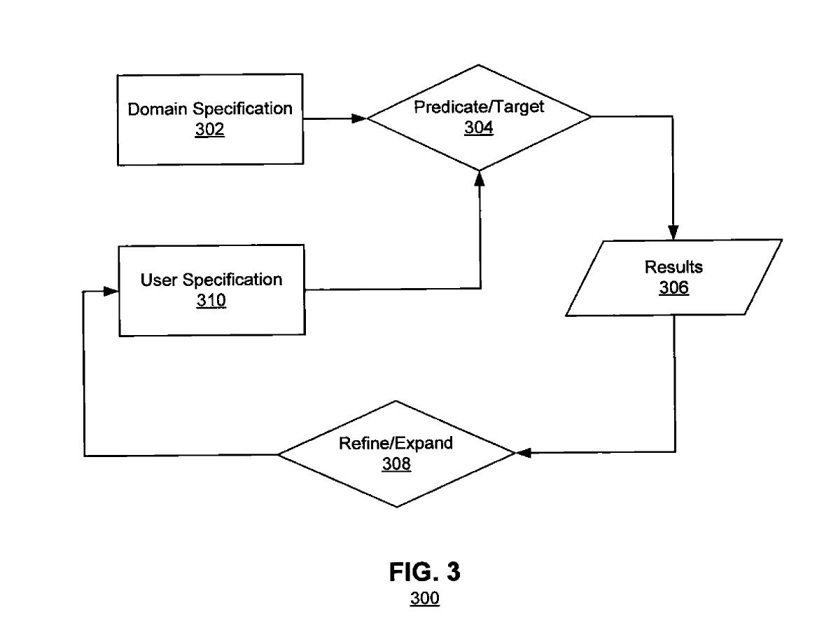

FIG. 3 is a block diagram of a query unit 300 according to an example embodiment. This query unit 300 includes a domain (system) specification 302 for the query and a user specification 310. The domain specification 302 can be combined with the user specification 310 to form a predicate and/or a target 304, which can produce results 306. The query can be refined and/or expanded 308 based on those results to alter the user specification 310 of the query.

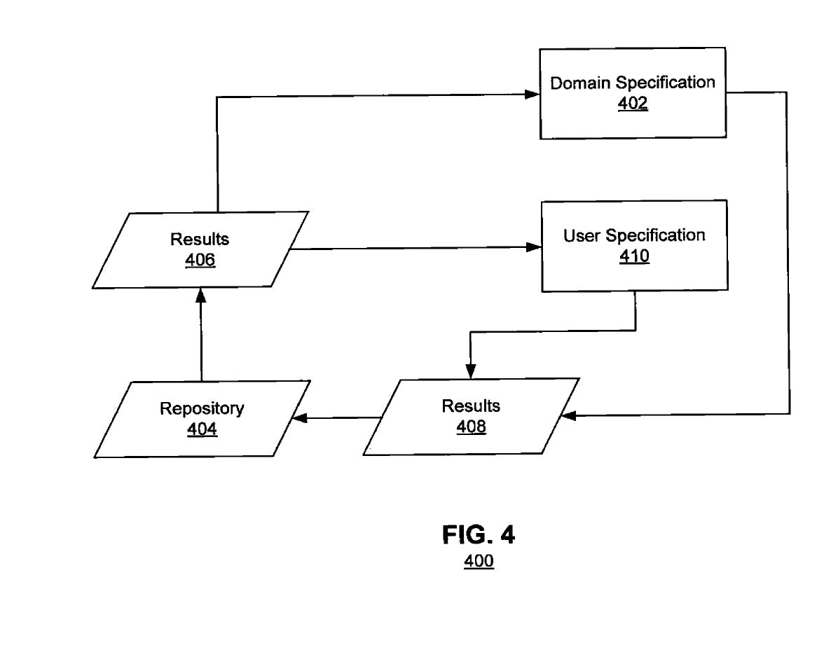

FIG. 4 is a block diagram of an analysis unit 400 according to an example embodiment. The analysis unit 400 generates transformation results 406, 408 based on repository data 404 returned from a query and/or a user specification 410. The transformed data can be in the form of images that are of the same dimensions and resolution as the data they are derived from, with changes to the individual pel positions and color depth based on the transformation. The domain specification 402 can check the results to determine and/or transform the results.

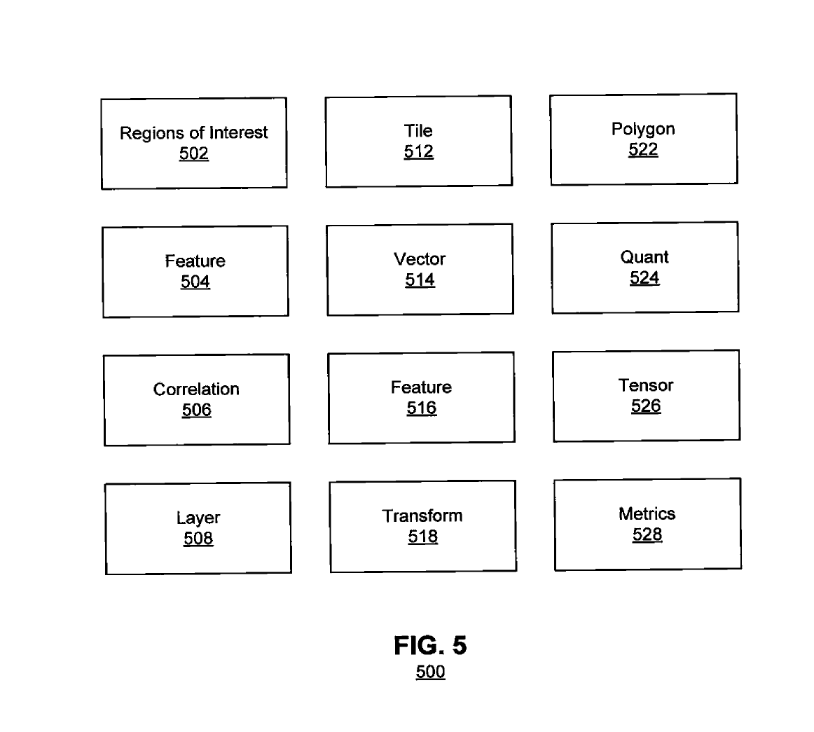

FIG. 5 shows an architecture of a query unit 500 in an intermediate stage according to an example embodiment. Intermediate results (“intermediates”) can be the result of a defined process performed to generate results. The intermediates can be dependent on a combination of a base repository state and defined processing.

In an embodiment, Regions of Interest (“ROI”) 502 define one or more neighboring pels in the repository, comprising one Tile 512 in the repository. The ROI 502 can also be a more complex Polygon 522 that can be defined on one or more tiles and whose interior is interpolated to discrete positions on one or more tiles. The tile data can be the decimation of the image data in scale and space generating the basic units of processing the tile. Vectors 514 can be feature vectors 504, 516 extracted from a tile, which can be used for generating indexes on which the queries operate. Correlation intermediates 506 can hold correlation between two tiles by way of their extracted feature vector similarity, for example, generated when one of the two tiles is a query predicate and the other is a query result. The correlation itself can be a feature index that can be searched. A tensor 526 can be formulated to transfer correlations to other feature vectors. Layers 508 can be any transformed 518, filtered, and/or visualized information derived from the data. Quant 524 can be a quantitative incremental process, involving, e.g., aggregate tile processing achieved through, e.g., scale-based constraints. Metrics 528 can be any of the scale-based constraints, thresholds, correlations, indexes, or other information.

In an embodiment, the data structure and content define a priority for the processing, and the priority can determine the order in which the data is provided to the user. This enables the user to understand both the structure and the content of the data. The user can be guided through the exploration of the data by this prioritization, which may limit the requirements for prior knowledge of the data.

In an embodiment, the processing is adjusted to the data being returned, expanding the sampling scope of the data being searched based on a sparse set of results being returned. Likewise, in an embodiment, the sampling scope can be restricted if a great volume of results are returned. The restriction can provide a wider sampling of the data, rather than a large amount of data being returned for a small localized subset of the total data.

In an embodiment, spatial continuity can assume that data spatially adjacent will generally be more relevant than distant data. Likewise, near data can have higher correlations with distant data for which the near data's neighboring data can also have high correlations for distant data. In an embodiment, these relationships can be used as bases for predicting the constraints of the search.

In an embodiment, usage statistics are used to expand processing of data that is generated and accessed to a greater degree than other data. Restriction and flushing of intermediate data can be performed in instances where data is generated and accessed infrequently. The frequency of access can influence ranking of the data. IAPE, the ranking data for user exploration, can be moderated with a bias compared to ranking based on system processing, based for example on screening slides for quality assurance (“QA”).

In an embodiment, as results are returned to the user, the system and method can provide a means by which the results are to be expanded and/or restricted. This online moderation capability provides the user with a means by which to interact with the query results. The same capability can be available to the user at any point in the query execution process, even when the query has finished. In such a case, the query is rerun with the new constraints. In an embodiment, queries and their incremental results are analyzed to determine if certain limits are reached which can make continued processing of the query inefficient, in which case the query can be terminated, and the user can be presented with the opportunity to alter the query.

In an embodiment, the partitioning and traversal of the data is performed to optimally maintain storage and computational coherency. In an embodiment, data can be partitioned regularly into non-overlapping spatial regions, e.g., blocks or tiles. In an embodiment, the data can be subsampled and partitioned. In an embodiment, partitioned data tiles are arranged based on scale and spatial proximity. The locality of each individual tile can act as the fundamental unit of computation. The result can be that this fundamental unit can be processed to yield a result that can be presented to the user.

In an embodiment, aggregate tile processing can be primarily achieved through scale-based constraints, where lower scale analysis is used to qualify the order of processing of higher scale data. For example, tissue image data scale-based pyramid maybe represented as a quad-tree decomposition of the image data. Parent-node similarity can used to qualify the representation. Increased access to side information can provide a pool of staged results that require only part of a pipeline to be executed.

In an embodiment, processing of the algorithm can be dependent upon the quantity of the results being returned. The traversal strategy can determine how the traversal tactics will be modified.

In an embodiment, given that the organization of the image data storage, and that of the derived data can be represented by a quad-tree decomposition, the granularity for each processing increment can be based on the processing of a subtree of the quad-tree. Cost estimation of the processing of the subtree can be used to bound the computation required to return a set of results. The isolation of processing to the subtrees can facilitate the application of parallel and distributed processing to scale the computation of the traversal.

In an embodiment, the quad-tree traversal can be defined to process subsets at each level, the number of subsets on each level determining the degree to which the traversal is breadth-first or depth-first. The breadth-first bias can sample a larger amount of data and utilize a larger amount of computing resources before returning a set of results. This increment can be advantageous when matching results are sparse and there is a weaker scale coherency. In an embodiment, breadth-first traversal can generally be more exhaustive and make fewer assumptions about the distribution of matching samples, which can indicate that predicate search hypotheses are weaker. In an embodiment, the depth-first bias can sample a smaller amount of data, using less computing time, and returning results in a smaller increment. This can be advantageous in cases where there are dense results and a stronger scale coherence.

In an embodiment, the exploration of the data can create many partial solutions to later queries. These partial solutions represent the opportunity to provide results in a more expedient manner compared with results that are calculated from less intermediate data. Since much of the partial results are created by the activities of other users, there can be a qualitative bias. A subset of results that have this bias can be returned.

In an embodiment, not only can this qualitative bias be available for increasing the efficiency of returning results, but it can also be referenced, e.g., counted, per data unit and recursively as an aggregate ranking of data utility.

In an embodiment, the challenges of tissue image data are addressed through system responsiveness that allows user specification refinement in addition to downstream processing in the pipeline. The specification refinement can be used to modify the current query processing to alter the results that are produced by the query. The downstream processing can operate on the query results as they are generated, performing additional transformations to the data, which can be followed by additional query processing. The responsive nature of the query processing can provide flexibility for the user to explore the data through query modification or further processing.

Base image data can be structured and organized for incremental processing over spatial and spectral scales. Upon import, data can be normalized spatially and spectrally through a calibration process. Data correlation can be determined by similarity in feature indices and maintained in correlation indices. Access and processing of data can be estimated and executed based on predicted and actual cost. Pre-calculations can be performed that approximate the result of the full calculation, provide computation cost estimates, and provide incremental calculation of the final result. Results can be rolled-up and aggregated for future calculations and intermediate products can be retained for update calculations, where online computation of algorithms is possible.

In an embodiment, the kernel utilizes the pyramidal/hierarchical/quad-tree data structure (e.g., multi-scale image pyramids) to facilitate progressive and isolated computation. In one non-limiting embodiment, tiles can be square images that have spatial extents of 256 on each dimension. These tiles can be generated from the original image and successive 2× subsampled versions of that image until the recursively subsampled image reaches a dimension below 256. Further, filesystem directories including the tiles can be subdivided into groups of 256, or an arrangement of 16 by 16 tiles. This filesystem organization can provide an optimal arrangement for storage system locality to take advantage of caching mechanisms. Further, the isolation anticipates distributed filesystems where operations on subregions can be executed without needing to share context information between separate computational environments.

In an embodiment, feature vectors based on histogram bins can be utilized in similarity comparisons of tiles. These can represent the approximation of the tile's contents used in indexing. Operations on tiles that are similar in this spectral feature space can be used to estimate the results of operations involving more computationally intensive feature extraction operations.

In an embodiment, the scale aspect of the technique emphasizes that the spectral feature vector is a ranked approximation of the spectral content of the tile. For example, if the feature vectors are the size of the tile, then each position would correspond exactly to each pixel. In an embodiment, having fewer bins than pixels necessarily can imply that the original data has been scaled down. The loss of correspondence between histogram bins and pixel positions can provide a spatial invariance.

In an embodiment, the kernel operates in an online manner, performing fine grain computations and consolidating the results. The computational cost of executing the computations can be factored into scheduling of the processing. The cost estimation may be performed and summarized for subtrees of the access plan. These estimates allow for the moderation of computation allowed for each subtree.

In an embodiment, the kernel is designed to operate incrementally on a pipeline of processing elements. The elements can be query elements followed by analysis elements. The query elements can apply one or more predicate patterns to a set of candidate patterns and return results based on pattern matching criteria. Analysis can be performed on the result set patterns, transforming them in some manner for at least one of visualization, further analysis, and query operations.

In an embodiment, the query itself generates intermediate products based on generating indices that are used in the pattern matching process. In an embodiment, the analysis process generates intermediate products in the form of filtered or transformed input image data or quantitative metrics.

In an embodiment, other intermediate products result from the approximating functions that generate approximated results. Additionally, online calculations can have intermediate products that are retained for the purpose of accelerating repeated processing, these can also considered intermediate products of the pipeline.

In an embodiment, retention and utilization of the intermediate products provide the kernel with alternative ways to generate results without incurring the computation required to repeat these operations.

In an embodiment, data such as tissue image data have distinct structures at different scales. These structures are not necessarily structurally coherent over the different scales. That is, the structural patterns are not necessarily repeating. The relationship between these patterns may modeled as a generating function where the macro-scale model is able to generate one or more micro-scale models. These models can be made available for providing additional constraints to queries. The kernel specific aspects of these models can be that, irrespective of the specific data, the kernel discovers these macro/micro models and can utilize them to provide joint similarity over different scales.

In an embodiment, in data management, the utility of the system is dependent on the characteristics and organization of the data. Tissue image data applications can put a priority on the retention of the original image data before the retention of derived data. Data management system configuration can reflect the archival priority and defines the storage, transfer, and analysis operations in reference to this prioritization.

In an embodiment, the magnitude of the data puts practical limits on data replication operations. When the magnitude is considered along with the long term retention policies associated with this data, constructing the database around the archived data can satisfy the requirements. The choice of archival format and data layout has an effect on the capabilities of all downstream processing.

In an embodiment, storage of data is based on the ability to manage the different tiers of data derived from the data. The retention and flushing of this data can be performed to satisfy storage and computation requirements based on the ability to re-generate such data on demand.

In an embodiment, the operations associated with the transfer and distribution of data can be achieved through the physical grouping of data and the ability to have out of scope references resolved through an addressing scheme. Limiting the dependencies can allow the system to have operational advantages when utilizing processing in distributed environments.

In an embodiment, the system can have operations that are executed automatically based on both routine operations and user interaction.

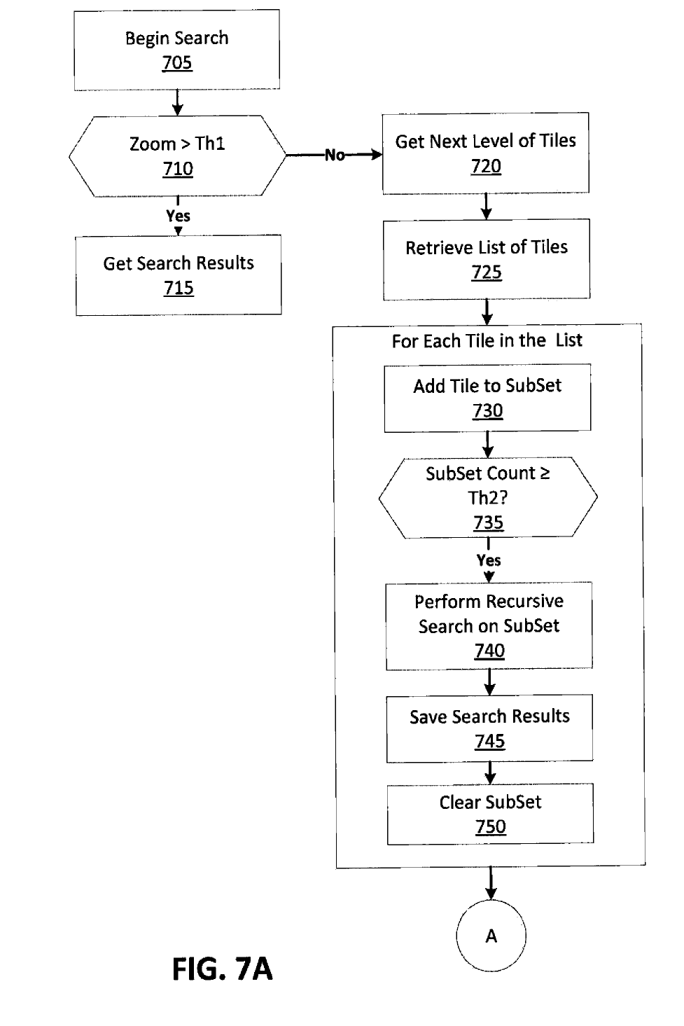

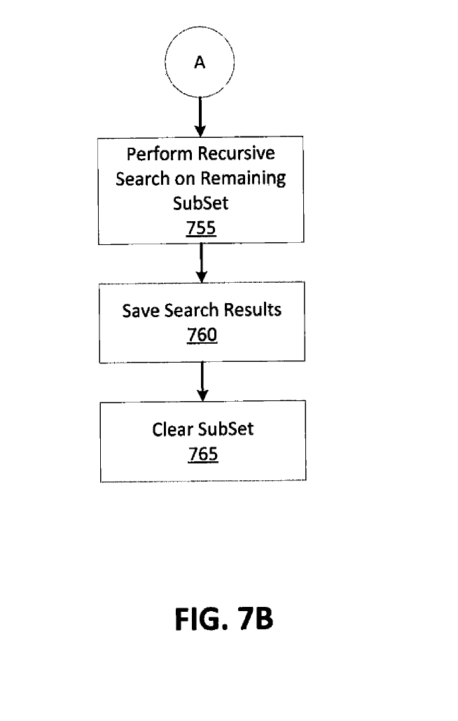

FIGS. 7A and 7B show a simplified flowchart illustrating a method of initiating a query by searching data according to an example embodiment. As shown in FIG. 7A, after a search is initiated (block 705), if the current zoom level or magnification (used interchangeably) of the image query image is greater than a predetermined threshold Th1 (block 710), the search results for the current level of inquiry will be returned (block 715).

In an embodiment, this threshold is set to limit unproductive searching, for example, so that the search exits if there are not a significant number of search matches being generated. Or, for example, this threshold is set to limit unproductive searching before the image becomes so pixelated that it no longer includes meaningful imagery. Or, for example, the threshold is set to limit the depth, in magnification levels or other way, of the search. For example, if a small number of matches is generated from using too small of a subset, then the subset size can be increased for a more broad search.

In an embodiment, if the search results were pre-computed, or computed during a previous exploration, the search results can be returned without executing the depth based search.

In an embodiment, the search function can be initiated recursively with different threshold values.

In an embodiment, each zoom level or magnification corresponds to a level of the quad-tree. For example, an image is composed of a single tile at magnification level 1. Then the correspondence of the image with its four children is considered magnification level two, the 16 tiles of the children of the children is considered zoom level 3, etc. Each level of magnification have a higher resolution, typically twice the resolution in each dimension, than the previous magnification level. When tiles reach the maximum resolution, those tiles can only correspond further to interpolated pixels as children and they are considered to be at the maximum zoom level or magnification. Through the decomposition into a quad-tree, the child tiles can have coherence with the parent tile, due to the parent tile being a down-sampling, a low-pass spatial filtering, of the four corresponding child tiles. For example, if a color is found in a parent tile, the same color is likely to be found in the child tile, or at least the parent color can be derived from the child tile's colors through a down-sampling operation.

In an embodiment, to retrieve search results, a list of result tiles meeting the current search criteria is queried from a memory. In an embodiment, the list of tiles is retrieved based on associated data, for example, the level of the tile, the query, a file name for the index associated with each tile, the result size, and/or the index type.

In an embodiment, the current search criteria, or query, limits the search results based on priorities and system resources. For example, the query can include limitations for computation available for the search or available time to complete the search, for the amount of memory available, or thresholds for quality or quantity of the search results.

In an embodiment, if the current magnification level is not greater than the predetermined threshold Th1 (block 710), the next level of tiles are then retrieved (block 720). This will retrieve or generate the quad-tree children of next level tiles corresponding to the current level. Then, from the next level of tiles, a list of tiles matching the current query results is created (block 725). In an embodiment, the query can be refined as more results are found. For example, the query includes a minimum result size. And, for example, as better matches are found, certain broader or earlier found results are removed from the result list by narrowing the query that retrieves results from memory.

In an embodiment, from the retrieved list, for each tile in the list, the tile is added to a subset (block 730). If the size, number of tiles, of the subset is greater than or equal to a predetermined threshold (block 735), a recursive depth first search is performed on the tiles in the subset (block 740). This limits the size of the set upon which the recursive set is performed. The results of the recursive search is then saved (block 745) and the set cleared (block 750). Then a recursive search is performed on the remaining set (block 755), the results saved (block 760), and the set cleared (block 765). The saved results are then available for retrieval from the memory from the time they are stored. In an embodiment, then, a continuously updated set of search results can be available even while the search is still running, or after the search has been completed.

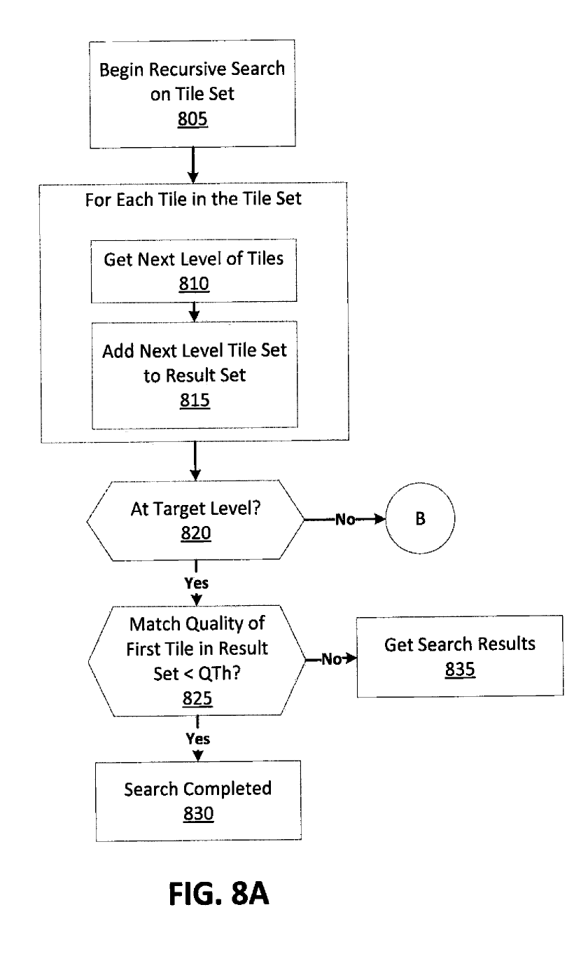

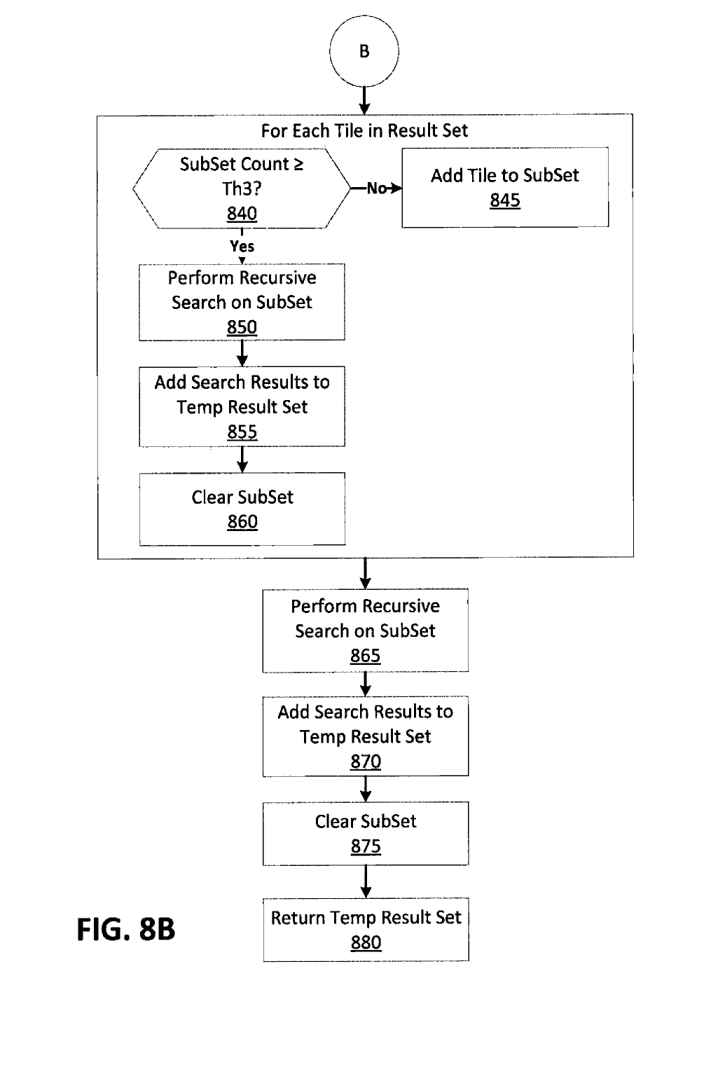

FIGS. 8A and 8B show a simplified flowchart illustrating a method for performing a recursive search according to an example embodiment. As shown in FIG. 8A, a recursive search is initiated on a set of tiles (block 805). To optimize the search, a new query tile can be developed, for example, as the first child tile of the first tile of input tile set (not shown). Then, for each tile in the set of tiles, the next level of tiles is retrieved (block 810) and the next level of tiles is added to a result set (block 815).

In an embodiment, once the result set has been populated, if the current zoom level is the target zoom level (block 820), the quality of the matches in the result set will be evaluated (block 825). For example, if the first tile in the result set has a match value of less than 50% when compared to the query tile, the results are too different from the query tile and the depth search will not continue along this branch of the quad-tree (block 830). However, if the results are sufficiently accurate, the current result set will be returned as the result of the recursive search (block 835). The minimum quality threshold may be set as part of the query.

According to an embodiment, the match quality is evaluated as a difference between vectors. For example, each pixel of a tile will have multiple values representing the color and/or luminance of the pixel. Then each tile has an array or vector of such values for all the pixels in the tile. Then, two tiles can be compared by calculating the distance, or mean squared error, between the vectors of the respective tiles.

In an embodiment, if the current magnification level is not the target level (block 820), the recursive search will continue as shown in FIG. 8B. As shown in FIG. 8B, for each tile in the result set, if a size of a subset is less than a predetermined threshold Th3 (block 840), the tile will be added to the subset (block 845). However, if the size of the subset is greater than or equal to the predetermined threshold Th3 (block 840), a new recursive search will be initiated on the subset (block 850). The results of that recursive search are added to a temporary result set (block 855) and the subset is cleared (block 860). As previously noted, this limits the size of the set upon which the recursive set is performed. Once each tile in the original result set has been processed and added to a subset, a recursive search will be performed on the remaining subset (block 865), the results added to the temporary result set (block 870), and the subset cleared (block 875). The temporary result set will then be returned as the results of the recursive search (block 880).

In an embodiment, the lists of tile(s) on each level are sorted based on their matching query tiles or matching the query tile(s)'s parent tile(s) if not at the target level.

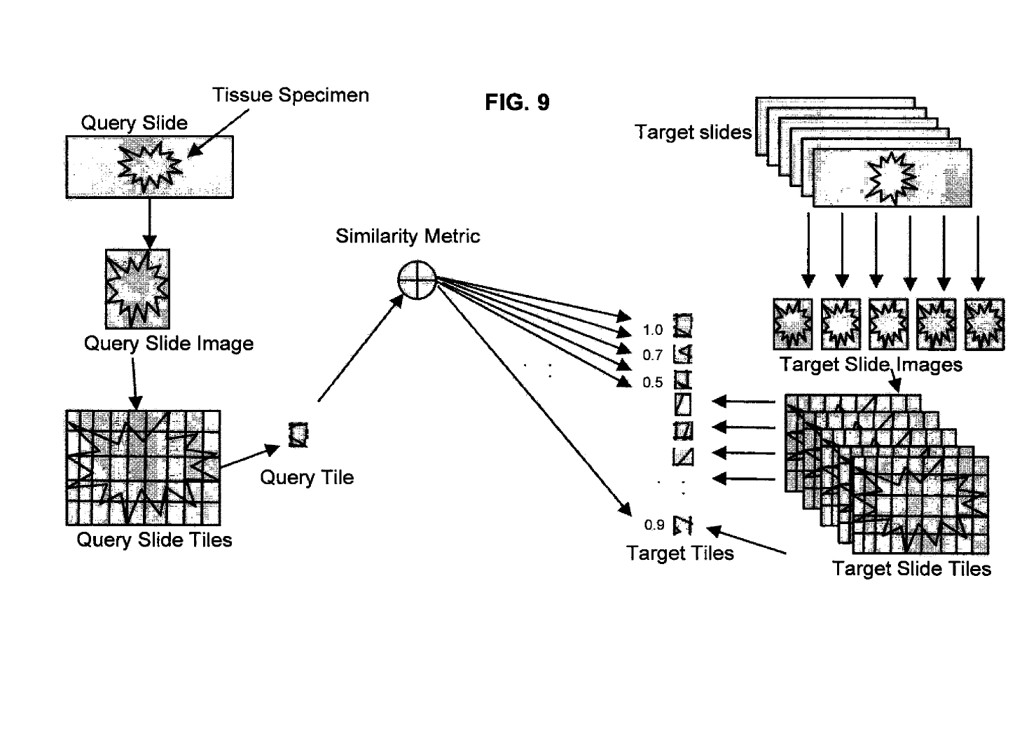

FIG. 9 shows a slide layout according to an embodiment of the present invention. Specifically, a biological tissue or other specimen is disposed on a query slide. From the query slide, a query slide image is prepared. For example, the query slide image is a digital file which is segmented spatially into square or other shape tiles. From the query slide tiles, one or more tiles are identified as the query or search tile(s). That information obtained from the query tile is then entered into a similarity metric engine. In an embodiment, the similarity metric engine normalizes the query tile to a preferred size and memory value.

In an embodiment, normalization can involve available methods. In an embodiment, normalization of one or more of the tiles or slide images involves obtaining the metadata information regarding the micron store pixel value. For example, if image A has a 20 micron per pixel scale and image B has a 40 micron per pixel scale, then an intermediate level can be calculated to level the micron per pixel scale of the two slides to be, e.g., both 20 micron per pixel scale or other level. In an embodiment, one may look for the highest resolution capture possible, an intermediate resolution capture possible, or the lowest resolution capture possible in order to obtain different results, depending upon the desired image search. In an embodiment, a color normalization or correction can be done. For example, the brightness, intensity, and color, of two or more tiles or images can be determined and then modified to a similar level for purposes of the searching. For example, if two different machines or scannings are done of the same slide, then those two resulting images can be normalized or color corrected so that any other slides from the same machine or machines can also be corrected based on the same determinations. For example, a comparison of the two scanned images' luminescent values, red-blue-green values, and other light or color based parameters can be made, then a determination can be made to modify one or both to a specific set of parameter levels, and then for any later images from same sources, the same modifications or corrections can be made with respect to the colors (color, brightness, intensity, et al.).

In an embodiment, the similarity metric engine compares the query tile(s) to target tiles located in one or more locations. For example, the target tiles are located in one or more databases in one or more geographical locations or servers. For example, at least one of the target tiles is taken from at least one target slide tile. The at least one target slide tile was prepared from target slide images or target slide digital image. The target slide images are either uploaded from a source and/or created from at least one target slide. The target slide is prepared using a tissue specimen or other sample.

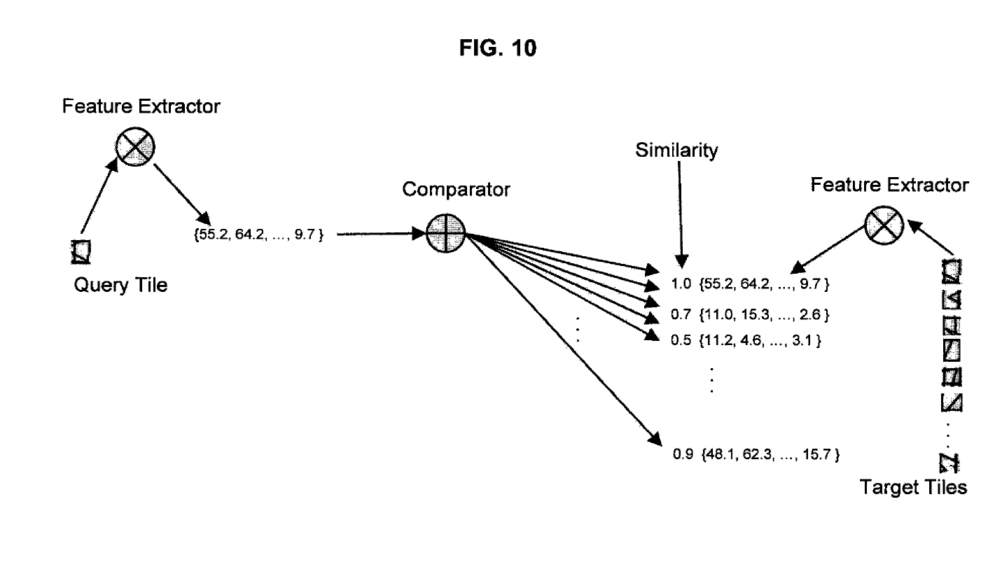

FIG. 10 shows an example tile feature comparison. A query tile or digital image query is entered into a feature extractor engine. The feature extractor engine determines specific parameters and/or features of the query tile. For example, the feature extractor engine uses a predetermined set of features to generate data and/or measurements on/of such as color pixels and size. Some or all of the data and/or measurements determined using the feature extractor engine are then entered into the comparator engine which compare the similarity of the feature(s) of the query tile with the data and/or measurements of one or more target tiles. The data and/or measurements of the one or more target files can be obtained using a feature extractor engine or the like.

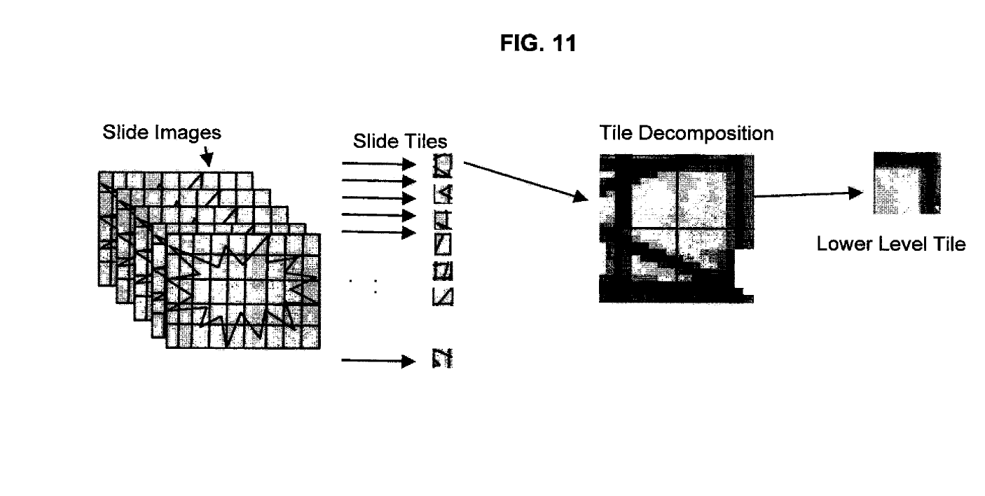

FIG. 11 shows an example tile spatial decomposition according to an embodiment of the present invention. A slide image is a digital file or other electronic data or information which is then identifiable as slide tiles or pieces of the slide image. The slide tile is then decomposed into a set of lower level tiles.

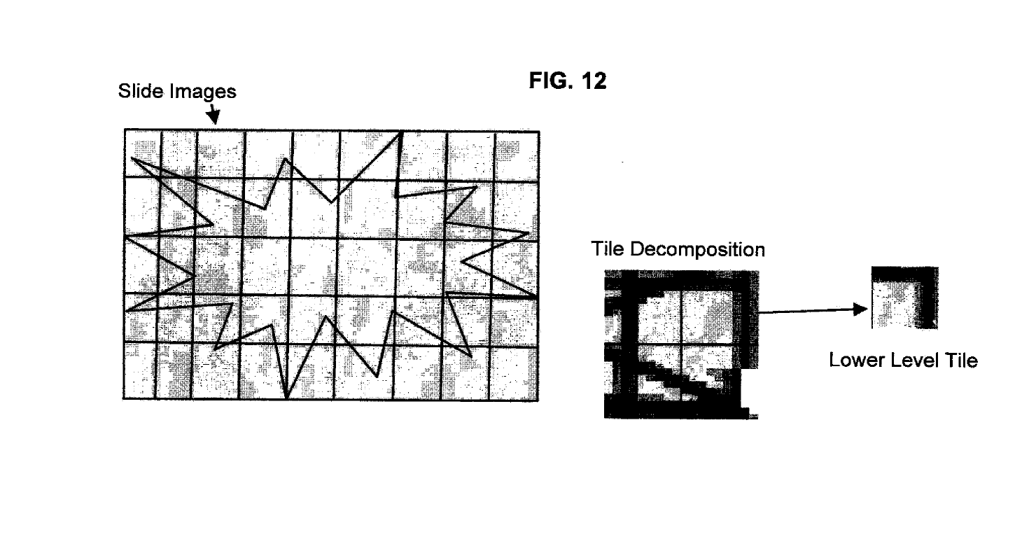

FIG. 12 shows an example tile scale decomposition according to an embodiment of the present invention. A slide image is segmented into multiple tiles, one of those tiles is then decomposed into multiple lower level tiles. One of those lower level tiles is then used in searching for other similar tile images, using, for example, the various embodiments described herein.

The present invention, including the embodiments described herein, can be implemented in digital electronic circuitry, computer hardware, firmware, software, computer program product, machine-readable storage device, propagated signal to control or execute a data processing apparatus such as a processor, a computer, or the like. The present invention, including the embodiments described herein, can be written in any form of programming language and can be implemented as a stand-alone program or as a component of another program. A computer program can be deployed, stored, executed, transmitted to and/or from, one or more computers in a single site or across multiple sites.

In the present invention, any method steps can be performed by one or more programmable processors, computers, tablets, smartphones, portable smart devices, and the like, executing a computer program to perform functions by operating on input data and generating output. Storage mediums can include EPROM, EEPROM, flash memory devices, chipcard, magnetic card, barcode, QR code, dvd-rom, cd-rom, internal hard disks, removable disks, magnetic disks, magneto-optical disks, or optical disks. The present invention can allow for interaction with a user by displaying from the computer to a display device, cathode ray tube (CRT) monitor, liquid crystal display (LCD) monitor, LED monitor, touchscreen, etc.

The present invention processes large amounts of data in some implementations. The data can be stored in a back-end component, e.g., a data server, an application server, cloud server, and a user interface capability, e.g., a keyboard, an audio-keyboard, graphical user interface, web browser, etc. In the present invention, components can be interconnected by any form of digital data communication, e.g., a communication network such as a local area network (LAN) and a wide area network (WAN) such as the Internet.

The descriptions and illustrations of the embodiments above should be read as exemplary and not limiting. For example, different parts of the above described embodiments can be used with and without each other in various combinations. Modifications, variations, and improvements are possible in light of the teachings above and the claims below, and are intended to be within the spirit and scope of the invention.

Although the present invention has been described with reference to particular examples and embodiments, it is understood that the present invention is not limited to those examples and embodiments. The present invention includes variations from the specific examples and embodiments described herein.

What is claimed is:

1. A computer-implemented method to search a database of images based on a query, the method comprising:
responsive to a determination that a magnification level of the query is greater than a first threshold, returning a first list of result tiles satisfying the query at the magnification level of the query;
responsive to a determination that the magnification level of the query is one of below and equal to, the first threshold, retrieving tiles at a next lower magnification level and returning a second list of result tiles satisfying the query at the next lower magnification level; and
processing each list of result tiles, the processing including, for each result tile:
adding the result tile to a subset of result tiles;
responsive to a determination that a total number of result tiles in the subset is one of: greater than and equal to, a second threshold, recursively searching the subset;
saving results of each recursive search of the subset to a remaining subset;
recursively searching the remaining subset; and
saving results of the search of the remaining subset.

2. The method of claim 1, wherein each level of magnification corresponds to a level of a quad tree, each level of the quad tree containing a tile representing an image result.

3. The method of claim 2, wherein a child tile has coherence with a parent tile.

4. The method of claim 3, wherein the parent tile is at least one of: a down-sampling and a low-pass spatial filtering, of at least one of the corresponding child tiles.

5. The method of claim 2, wherein the retrieving of tiles at the next lower magnification level includes generating children at a next lower level of the quad-tree.

6. The method of claim 1, wherein the query includes at least one of: a minimum threshold number of results and a maximum threshold number of results.

7. The method of claim 1, wherein the query includes an image and the magnification level of the query is a magnification level of the image.

8. The method of claim 7, wherein a result tile is included in the list for returning based on at least one of: a magnification of the result tile, the query image, a file name for an index associated with the result tile, a result size, and an index type.

9. The method of claim 1, wherein the first predetermined threshold is defined such that the method terminates responsive to a determination that a number of search results are below a value.

10. The method of claim 1, wherein the query is updated after returning the first list of result tiles.

11. The method of claim 1, further comprising removing results from at least one of: the first list of result tiles and the second list of result tiles prior to processing the respective list of result tiles.

12. The method of claim 1, wherein the query includes a threshold level of quality.

13. The method of claim 1, wherein the query includes a time limit within which to perform the search.

14. A method of performing a recursive search of a tile set based on a query tile, the method comprising:
for each tile in the tile set, performing the following steps until a result set is populated:
retrieving a set of tiles from the next level;
adding the next level tile set to the result set;
responsive to a determination that a magnification level is at a predetermined target level, evaluating a quality of matches in the result set;
responsive to a determination that a magnification level is below the target level, for each tile in the result set:
responsive to a determination that a number of tiles in a subset is at least one of: greater than and equal to a third threshold value, adding the tile to the subset;
responsive to a determination that a number of tiles in the subset is less than the third threshold value, performing the steps of:
recursively searching the subset;
adding results of the recursive search to a temporary result set; and
clearing the subset;
recursively searching the subset;
adding search results to the temporary result set;
clearing the subset; and
returning the temporary result set.

15. The method of claim 14, wherein the evaluating of the quality of matches includes determining whether a first tile in the result set has a match value of less than a predetermined value compared with the query tile.

16. The method of claim 14, wherein each pixel of a tile has at least one value representing at least one of: a color and a luminance of the respective pixel and each tile includes a vector of the at least one value for all pixels of the tile.

17. A computer-implemented method of continuously processing a repository of image data, the method comprising:
receiving query specification including a request for data;
receiving system specification of the computer on which the method is implemented;
comparing the query specification and the system specification to determine a domain specification;
initiating a query on the repository based on the domain specification;
receiving results of the query including image data;
rendering an interactive and iterative exploration of the result image data on a graphical user interface;
receiving input of the result image data via the graphical user interface;
updating the query based on the received input;
rendering an updated the graphical user interface based on updated result image data.

18. The method of claim 17, wherein the repository of image data includes digital microscopy data.

19. The method of claim 17, wherein the continuous process of the image data generates results in an incrementally such that results are available prior to full termination of the processing.

20. The method of claim 17, wherein the query specification implicitly defines indexes and transformation of data.
